(19) United States
(12) Patent Application Publication
(10) Pub. No.: US 2005/0101231 A1
(43) Pub. Date: May 12, 2005

(54) Razor sharpening apparatus

(76) Inventor: Michael Edward Sekerich, Spring Valley, NY (US)

Correspondence Address: Robert E. Cannuscio;DRINKER BIDDLE & REATH LLP, One Logan Square, 18th & Cherry Streets, Philadelphia, PA, 19103-6996, US

(21) Appl. No.: 10/958,856

(22) Filed: Oct. 5, 2004

Related U.S. Application Data
(60) Provisional application No. 60/518,083, filed on Nov. 10, 2003.

(51) Int. Cl. B26B 21/14

(52) U.S. Cl. 451/234

(57) ABSTRACT

A sharpening apparatus for razors includes a blade sharpener rotatably supported within a housing and driven by a motor. An opening in the housing provides access to the blade sharpener for a blade head of a razor containing one or more blades. The rotatably supported blade sharpener includes at least one sharpening element on a body, the sharpening element presenting an abrasive outer surface for contacting the blades. The body may be a carrier and the sharpening element may be abrasive rods located in channels in the carrier. The body is rotatably supported by a shaft. The housing may include a removable guide frame including an opening and having rim walls adjacent the opening for positioning the blade head. The body may also include a polishing material.

### CROSS-REFERENCE TO RELATED APPLICATION

The present application claims priority from U.S. Provisional Application No. 60/518,083, filed Nov. 10, 2003, which is incorporated herein by reference in its entirety.

### FIELD OF THE INVENTION

The present invention relates to blade sharpening apparatuses and, more particularly, to an apparatus for sharpening razors having one or more blades housed in a blade head.

### BACKGROUND OF THE INVENTION

Razors having a handle, and one or more blades housed in a head connected or releasably connected to the handle, are used by both men and women for personal shaving needs. The term “razor” as used herein is not limited to handles that are integrally connected to a blade head but rather is intended to include handles that are either integral with or removably attachable to the blade head. Furthermore, the term “blade head” covers integral blade heads or blade cartridges that include one or more blades and which are releasably connected to the handle to permit replacement of the cartridge. The blade sharpener of the present invention, therefore, could be used to sharpen razors having either integral blade heads or replaceable blade cartridges. Razors having cartridge blade heads reduce waste because the handle portion of the razor is retained by a consumer for use with multiple cartridges. Razors are convenient to use for a variety of reasons. For example, there is no need for a user to handle the blades of the razor because the blades are already mounted in the blade head of the razor. Also, razors are typically lightweight and ergonomically designed to be comfortable when held by the user.

While razors are capable of providing multiple shaves, the number of uses of each razor, or blade head, is limited. The cutting edges of the individual razor blades that shear hair, are dulled by use and may become unfit for shaving after only a few uses. Most razors are not equipped with sharpeners. As a result, the razor, or the blade head, must be discarded when its useful life is reached. The life of the average razor, or blade head, is estimated to be approximately three to seven shaves. Assuming a user that shaves daily, approximately seventy razors or blade heads would need to be purchased and discarded annually. This is not only costly, but adds to the environmental burden of discarded plastic, packaging and metal.

Known devices for sharpening blades are shown in U.S. Pat. Nos. 1,859,554; 2,098,465; 2,331,370; 2,458,257; 2,511,188; 2,565,281; 3,057,062; 3,854,251; 3,979,857; 4,974,322; 5,036,731; 5,139,138; 5,785,586; 6,030,281; 6,488,834; 6,506,106; Des. 162,356; Des. 211,482, and Des. 446,883. The sharpener disclosed in each of these references has one or more disadvantages. For example, the sharpening action for some of the devices must be provided manually by a user requiring effort and time to achieve the benefit of sharpening. Other known devices that are motor-driven to provide blade sharpening, rely upon an external power source. Such devices lack portability. Some of these devices, in which the external power source is that typically supplied to a household at 120 volts AC, present a potential electrical hazard when the sharpener is used in wet environments. Other known sharpening devices are directed to sharpening razor blades that are intended to be inserted by a user into a blade head. Such devices, therefore, cannot be used to sharpen the razor blades of a razor. Other known sharpening devices are included in combination with shavers, thereby adding weight to the shaver and resulting in a less ergonomic design.

### SUMMARY OF THE INVENTION

The present invention provides an apparatus for sharpening the blades of a razor. The razor includes a blade head in which the blades are retained and a handle connected to the blade head for manipulating the blade head. The sharpening apparatus comprises a housing defining an interior space and an opening adapted to receive the blade head of a razor. The apparatus also includes a blade sharpener located within the housing adjacent to the opening. The blade sharpener is rotatably supported for rotation about an axis and includes at least one sharpening element having an abrasive outer surface arranged for contact with a blade of the blade head. The apparatus further includes a drive mechanism, such as a motor, operably connected to the blade sharpener to rotate the blade sharpener about the axis.

According to one embodiment, the rotatably supported blade sharpener includes an elongated body and the sharpening element is an abrasive material formed on the outside of the body. According to another embodiment, the elongated body is a carrier and the sharpening element is one or more abrasive rods received in longitudinal channels formed in the carrier. The elongated body includes a support shaft that is preferably connected to an output shaft of the motor through gears to transfer rotation of the output shaft to rotation of the blade sharpener.

Preferably, the apparatus also includes a power source for the motor located within the housing. The power source may include one or more batteries, which may or may not be rechargeable. The housing preferably includes a top defining the opening and may include a recess in which the handle of the razor is nestingly received.

According to one embodiment, the apparatus includes a guide frame having an opening and rim walls located adjacent the opening for positioning the blade head of a razor against the blade sharpener. The guide frame may be adapted for removable attachment to the housing. The apparatus may include a plurality of different guide frames, each adapted to receive the blade head of one or more different types of razors.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a side elevation view of a sharpening apparatus according to the invention shown with a razor seated on the housing of the sharpening apparatus.

FIG. 2 is a sectional view of the sharpening apparatus of FIG. 1 taken along the lines 2-2 in FIG. 1.

FIG. 3 is a partial side view of the sharpening apparatus of FIG. 1 showing the blades of a razor contacting the blade sharpener.

FIG. 4 is a perspective view of the blade sharpener and razor of FIG. 3, the razor shown without its handle.

FIG. 5 is an end view of a blade sharpener according to another embodiment of the invention having an elongated rod carrier and a pair of abrasive rods received in longitudinal channels formed on the rod carrier, the blade sharpener shown without a support shaft received in a central passage of the rod carrier.

FIG. 6 is an exploded perspective view of the rod carrier of the blade sharpener of FIG. 5 and one of the abrasive rods.

FIG. 7 is a partial side view of a sharpening apparatus incorporating the rod carrier and abrasive rods of the blade sharpener of FIG. 5 and shown with the blades of a razor contacting the blade sharpener, the apparatus otherwise similar in construction to apparatus shown in FIGS. 1 through 3.

FIG. 8 is a side elevation view, partly in section, of a sharpening apparatus according to another embodiment of the invention.

FIG. 9 is a top plan view of the sharpening apparatus of FIG. 8, shown without the top of the housing for clarity.

FIG. 10 is an enlarged detail view of a portion of the sharpening apparatus taken from FIG. 9.

FIG. 11 is a partial sectional view of the sharpening apparatus of FIG. 9 taken along the lines 11-11 of FIG. 9.

FIG. 12 is a sectional view of a blade sharpener according to the invention having an abrasive outer member and an inner carrier member received within an interior of the outer member, the blade sharpener shown without a support shaft received in a central passage of the inner carrier.

FIG. 13 is a perspective view of a sharpening apparatus according to the invention including a housing and a removable guide frame for positioning a razor, the guide frame shown removed from the housing.

FIG. 14 is a perspective view of the sharpening apparatus of FIG. 13, the guide frame releasably attached to the housing.

FIG. 15 is a partial sectional view of the sharpening apparatus of FIG. 14 shown with a razor received by the guide frame.

### DETAILED DESCRIPTION OF THE DRAWINGS

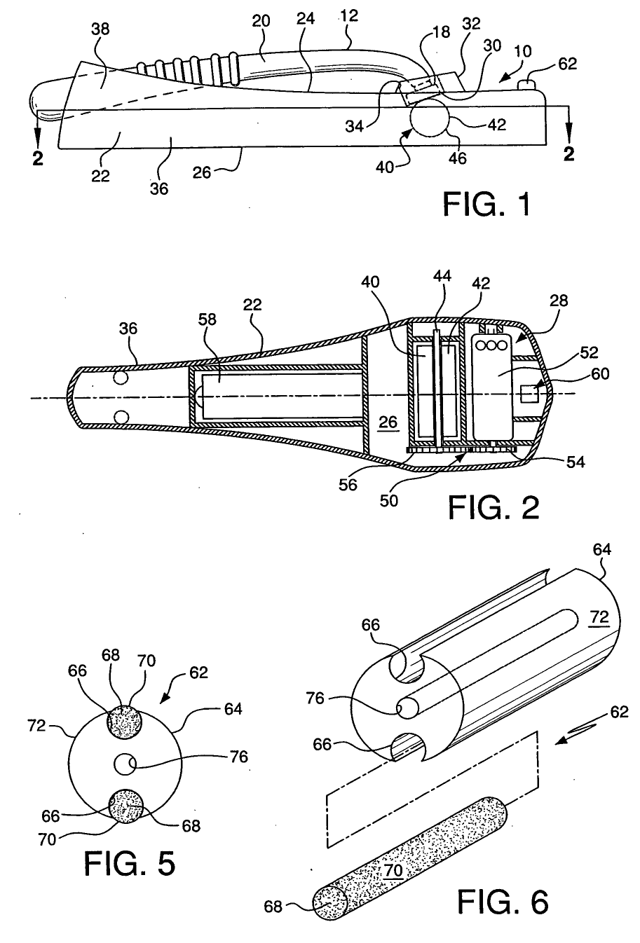

Referring to the drawings, where like numerals refer to like elements, there is shown in FIGS. 1 through 4 an apparatus 10 according to the invention for sharpening a razor 12. The apparatus 10 includes a housing 14 on which the razor 12 is seated in FIG. 1. The sharpening apparatus according to the present invention greatly increases the useful life of the blades of the blade head of the razor while providing other desirable features such as motor drive, cost efficiency, low weight, and ergonomic portability. It has been found that the sharpening apparatus of the present invention substantially increases the blade life of a blade head compared to the approximately three to seven shaves for the blades of a razor that are not sharpened.

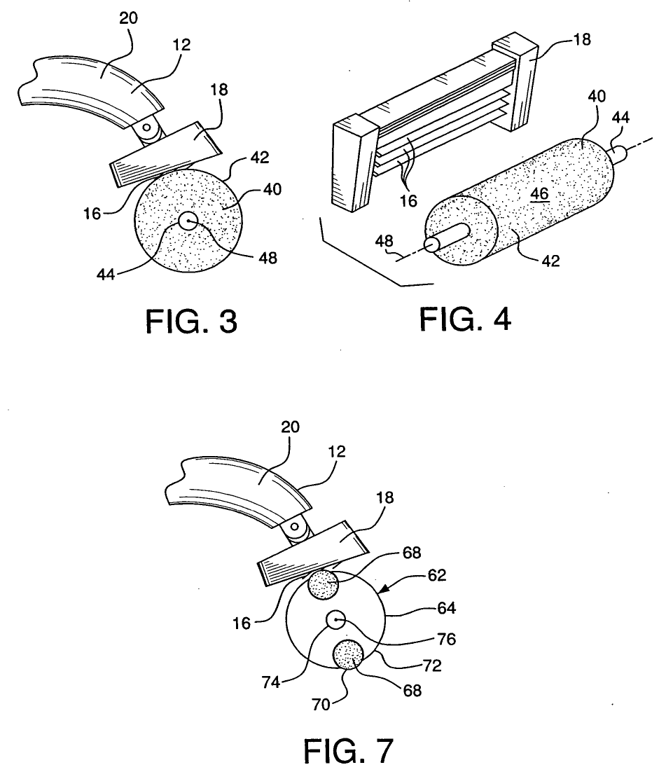

Referring to FIGS. 3 and 4, the razor 12 includes one or more blades 16 contained within a blade head 18. The razor 12 also includes a handle 20 connected to the blade head 18 to facilitate manipulation of the blade head. The razor 12 is shown in FIG. 4 without the handle 20 and with part of the blade head 18 removed for clarity of view. As discussed above, the term “blade head” is defined as a housing for one or more blades. The blade head can be either integral with the razor handle or can be a blade cartridge that is adapted to releasably attach to the razor handle. As such, the term “razor” covers devices with blade heads that are either integral with or releasably attached to the handle. The blade sharpener of the present invention, therefore, could be used to sharpen razors having either integral blade heads or replaceable blade cartridges.

Referring again to FIGS. 1 and 2, the housing 14 of the razor sharpening apparatus 10 includes side walls 22, a top 24, and a bottom 26. The housing 14 defines an interior space in which a sharpening mechanism 28 of the sharpening apparatus 10, described below in greater detail, is contained. Preferably, the housing 14 is constructed from a plastic material. The use of a plastic material for the housing 14 desirably facilitates a lightweight, durable, construction.

As shown in FIG. 1, the housing 14 includes an opening 30 formed in the top 24 of the housing. The opening 30 is dimensioned for receipt of the blade head 18 of razor 12 to provide access to the sharpening mechanism 28 contained within the housing 14 for sharpening of the blades 16. Preferably, the opening 30 is substantially rectangular to accommodate the blade head 18 that, as shown in FIG. 4, is generally rectangular in configuration. The shape of the opening 30, however, need not be a true rectangle and could have other shapes. For example, the opening 30 could include rounded ends to facilitate manufacture.

The housing 14 preferably includes a guide frame 32 located at the opening 30 and having substantially upstanding walls 34 that surround the opening 30. The walls 34 of the guide frame 32 function to retain the blade head 18 of razor 12 and position the blade head 18 with respect to the opening 30 of housing 14.

As shown in FIG. 1, the housing 14 is preferably elongated to include an end portion 36 that provides for support of the handle 20 of razor 12. The elongated shape for the housing 14 also facilitates ergonomic handling of the apparatus. The housing 14 also preferably includes a recessed portion 38 adjacent a terminal end of the housing for nested seating of the handle 20 of razor 12 near a distal end of the handle. The nested seating of the handle 20 by the recessed portion 38 of housing 14 serves to retain the razor 12 on the housing 14 with the blade head 18 properly positioned with respect to the opening 30 for optimum sharpening. It should be understood, however, that, while the recessed portion 38 of housing 14 is preferred, it is not required. Also, the housing 14 need not be elongated as described above to support the handle 20 of the razor 12. Thus, it is within the scope of the invention that the housing 14 be reduced in size to only that necessary to house the sharpening mechanism 28.

The sharpening mechanism 28, which is located within the interior space of the housing 14, includes a rotatingly supported blade sharpener 40 having an elongated body 42, which is preferably substantially cylindrical. A support shaft 44 extends out from the body 42. The body 42 of the blade sharpener 40 includes an abrasive outer surface or element 46 for sharpening the blades 16 of razor 12. Referring now to FIGS. 3 and 4, one embodiment of the body is shown. In this embodiment, the body 42 of the blade sharpener 40 is made from a material used to make sharpening stones such as silicon carbide or aluminum oxide and, thus, forms the abrasive outer surface 46. However, any suitable material which provides a sufficiently abrasive surface could be used, including ceramics for example. Referring to FIG. 4, the blade sharpener body 42 preferably has a length that is approximately equal to the length of the cutting edges of the razor blades 16 measured along a line essentially perpendicular to the axis of the handle 20. As a result, the abrasive outer surface 46 of the blade sharpener body 42 will engage only the blades 16 and not the blade head 18.

The support shaft 44 of the blade sharpener 40 may be received in a central passage of the body 42 such that rotation of the support shaft 44 results in rotation of the body 42 about an axis 48 defined by the shaft. As shown in FIG. 2, opposite ends of the support shaft 44 are supported on upstanding walls within the interior space of the housing 14. The blade sharpener 40 is located adjacent the opening 30 of housing 14 such that, as shown in FIGS. 1 and 3, the abrasive outer surface 46 of the body 42 contacts the blades 16 of blade head 18 when the razor 12 is seated on the housing 14. As shown in FIGS. 3 and 4, the blade sharpener 40 is supported within the housing 14 such that the cutting edges of the blades 16 extend substantially parallel to the axis of rotation 48 for the blade sharpener 40.

The amount of sharpening that is required will depend on multiple factors including the dullness of the blades 16, the material composition of the blades, the material composition of the abrasive body of the blade sharpener 42 and the speed of rotation of the blade sharpener 40. However, it is anticipated that blade sharpening will occur in about three to five seconds.

The sharpening mechanism 28 further includes a drive mechanism or system 50 engaging the blade sharpener 40 to rotate the body 42 about the axis 48. In one embodiment, the drive system 50 includes a motor 52 having a rotatingly driven output shaft and a first gear 54 connected to the output shaft of the motor 52 for rotation therewith. Preferably, the motor is a DC motor. The drive system 50 further includes a second gear 56 connected to an end of the blade sharpener support shaft 44 for rotation therewith. Each of the gears 54, 56 includes teeth formed about an outer periphery. As shown in FIG. 2, the motor 52 is mounted within the housing 14 substantially parallel to the blade sharpener support shaft 44, and offset therefrom, such that the teeth of the gears 54, 56 meshingly engage each other to transfer rotation of the output shaft of motor 52 to rotation of the support shaft 44, and the body 42 mounted thereon. Other means for transferring rotation between the motor 52 and the blade sharpener 40 could be used instead of a geared system, such as a belts, pulleys and/or rollers.

The sharpening mechanism 28 includes at least one battery 58 mounted within the housing 14 to provide an internal power source for the motor 52 of drive system 50. The battery 58 may be a conventional disposable battery, or may be a rechargeable battery. If the battery 58 is rechargeable, conventional electrical connections between the battery and an external power source, such as an A/C outlet, would preferably also be included. A removable cover or access panel may be formed in the housing 14 at the location of the battery 58. It is also within the scope of the invention that the razor sharpening apparatus 10 could be constructed for disposal following depletion of the internal power source. For such a disposable apparatus, no access to the internal power source would be required. It is also contemplated that the apparatus could be constructed without an internal power source and, instead, be adapted for connection to a source of power located externally of the housing 14.

The sharpening mechanism 28 also preferably includes a switch. 60 mounted within the housing 14 and including a button 62 extending from the top 24 of the housing 14 for actuation of the mechanism 28 by a user. When the switch 60 is actuated by a user, power is supplied to the motor 52 causing the motor 52 to rotate the support shaft 44 on which the blade sharpener body 42 is mounted. It is also contemplated that the motor may be automatically activated upon sensing of a razor 12 or a blade head 18. For example, an optical or pressure sensor may be located near the opening for sensing when a blade head is located within the opening. A signal would be provided to the motor to cause it to begin to rotate the sharpener body 42. Alternatively, a pressure sensor could be located within the recess for sensing when the handle of the razor is seated in the recess. Again, a signal would be sent to the motor to activate it. Those skilled in the art would be readily capable of incorporating these and other mechanisms for automatically activating the motor into the present invention. Upon activation, the device may be configured with conventional circuitry to operate for a predetermined period of time, e.g., 3 seconds.

Referring to FIGS. 5-7, there is shown a blade sharpener 62 according to another embodiment of the invention. The blade sharpener 62 includes an elongated body which, in this embodiment, is a carrier 64. The carrier 64 includes channels 66 extending longitudinally along the carrier 64. In the illustrated embodiment, the channels are located on opposite sides of the carrier. However, the arrangement and number of channels can vary as will become apparent below. The blade sharpener 62 also includes a pair of rods 68 located in the channels 66 of the carrier 64. In one embodiment, each of the rods 68 is preferably made from a material comprising approximately 99 percent of an alumina ceramic to provide an abrasive outer surface 70. Other materials presenting an abrasive outer surface could be used to form the blade sharpener rods 68.

As shown in FIGS. 5 and 7, the channels 66 of carrier 64 are dimensioned with respect to the rods 68 such that a portion of each rod 68 extends outwardly, preferably radially, beyond an outer surface 72 of the carrier 64. This arrangement facilitates contact between the abrasive outer surfaces 70 of rods 68 and the blades 16 of razor 12, when the razor 12 is seated on the housing (not shown) to position the blade head 18 with respect to the blade sharpener 62 as shown in FIG. 7. In one preferred embodiment of the invention, the rods 68 extend about 0.5 mm beyond the outer surface 72 of the rod carrier 64.

As shown in FIG. 5, the rods 68 and the channels 66 are also dimensioned such that the rods 68 are retained in the channels 66 of the carrier 64. The rods 68 may be inserted into the channels 66 of the carrier 64 by application of a pressing force in a snap-fit manner. Alternatively, it is contemplated that the rods 68 could be inserted lengthwise into the channels 66 from an axial end of the carrier 64. In one embodiment, the rods 68 are preferably substantially cylindrical in shape as shown. It is contemplated, however, that the rods could be formed in various shapes and retained by various channel configurations. As should be readily apparent, the amount that the rod projects outward and the shape of the portion of the rod that extends beyond the outer surface of the carrier can be varied to provide the degree of contact desired for the blade being sharpened.

The blade sharpener 62 also includes a support shaft 74 (FIG. 7) formed in the carrier 64. In a similar manner to the body 42 of blade sharpener 40, the carrier 64 is mounted on support shaft 74 such that rotation of the shaft 74 results in rotation of the carrier 64 about an axis 76. The blade sharpener 62 is preferably mounted in a housing (not shown) of an apparatus otherwise similar to apparatus 10 described above. The relative orientation between the blade sharpener 62 and the razor 12 is generally shown in FIG. 7. The blade head 18 of razor 12 is preferably oriented so as to provide optimum sharpening (and/or polishing) contact between the rods 68 and the middle blade 16 of the three-bladed razor (i.e., substantially parallel orientation between the surface 70 of rods 68 and the surface of the central blade that is contacted). Preferably the orientation of the blade head 18 is such that the middle blade of a three blade razor contacts the outer surface 72 of the carrier 64 at the tangent point to the carrier. This orientation results in the rods 68 contacting not only the middle blade, but also the blades on either side.

If the razor being sharpened is a two-bladed razor then the blade head is preferably oriented such that there is one blade on either side of the point of tangency with the outer surface of the carrier. This arrangement would serve to optimize sharpening by equally dividing the sharpening contact between the two blades 16. Similarly, if the razor being sharpened is a four-bladed razor, the blade head should be positioned such that two blades are on either side of the point of tangency. If the razor being sharpened is a single-bladed razor, the blade head should be positioned such that the rod contacts the single blade.

In order to maximize contact between each of the blades 16 of the three-bladed blade head 18, it is preferable that the housing guide the blade head 18 but otherwise not constrain the blade head 18. Supported in this manner, the blades 16 would normally slide along the outer surface of the rod carrier 64 until they are contacted by the rods 68.

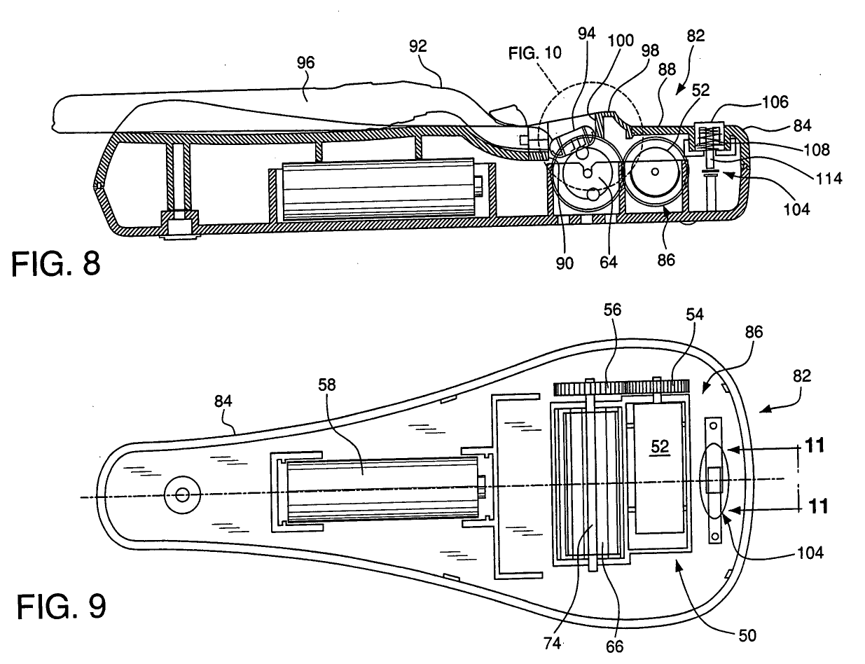

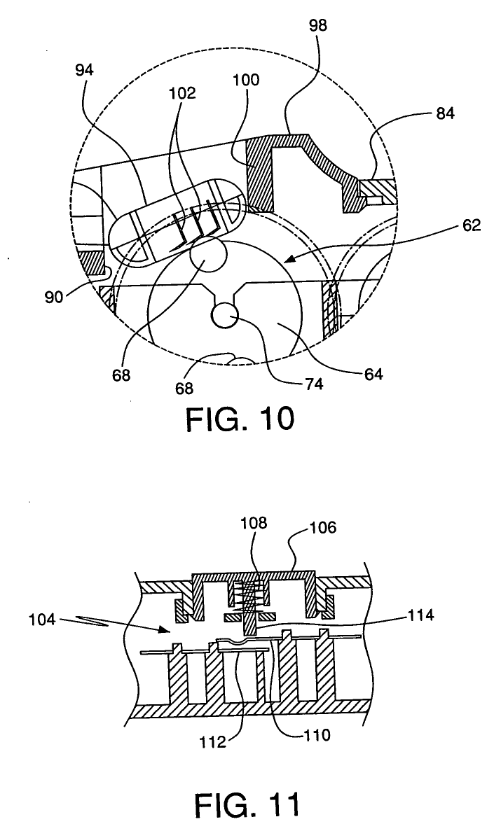

Referring to FIGS. 8-11, there is shown an apparatus 82 according to another embodiment of the invention. The apparatus 82 includes a housing 84 defining an interior space in which a sharpening mechanism 86 is contained. In a similar fashion as the housing 14 of apparatus 10, the housing 84 of apparatus 82 includes an opening 90 in a top 88 that provides access for the blade head 94 of a razor 92 to the sharpening mechanism 86 located in the interior space. As shown in FIG. 8, a portion of the top 88 adjacent the opening 90 is indented to accommodate an angled portion of a handle 96 of razor 92 when the razor 92 is seated on the housing 84. Also, as shown in FIG. 9, a guide frame 98 of housing 84 is adjacent to the opening 90. The guide frame 98 does not completely surround the opening 90 in order to accommodate the angled portion of the razor handle 96. Preferably, however, the guide frame 98 of housing 84 includes substantially upstanding walls 100 adjacent each of the back and sides of the opening 90 for positioning the blade head 94 of the razor 92 with respect to the sharpening mechanism 86.

The sharpening mechanism 86 of apparatus 82 incorporates blade sharpener 62 of FIGS. 5 through 7. Similar to the above-described orientation shown generally in FIG. 7, it is preferable that the guide frame 98 of housing 84 orients the blade head 94 of razor 92 for optimum contact between the carrier, rods 68 and the blades 16. As was discussed above, it is preferable that the guide frame 98 of housing 84 guide the blade head 94 but otherwise not constrain the blade head such that the blade head is substantially supported in a free-floating manner on the blade sharpener 62.

The sharpening mechanism 86 of apparatus 82 also includes a drive system or mechanism 50 including a motor 52 and gears 54, 56 and a battery 58 for powering the drive system 50. The drive system 50 is similar to that of apparatus 10 except that the gears 54, 56 engage the opposite end of the output shaft of the motor 52 and blade sharpener support shaft 74 from that of apparatus 10.

The apparatus 82 includes a switch 104 for actuation of the sharpening mechanism 86 by a user. Referring to FIGS. 8 and 11, the switch includes a button 106 that is received by an opening in the top of housing 84 for sliding movement with respect to the housing. The switch button 106 is outwardly biased with respect to the housing 84 by a spring 108 such that the button 106 normally extends from the top 88 of housing 84 as shown in FIG. 11. The switch 104 also includes a pair of electrically conductive contact elements 110, 112 mounted within the interior of housing 84. In the outwardly biased position of the button 106, the contact elements 110, 112 are separated from each other, as shown in FIG. 11. The upper contact element 110 is flexible to provide for contact between the normally separated contact elements 110, 112 when the switch is actuated by a user. As should be understood by one skilled in the art, inward movement of the button 106 during actuation by a user will cause a post 114 connected to the button 106 to deflect upper contact element 110 into contact with the lower switch element 112 thereby closing a circuit for delivery of current to motor 52. Upon release of the button 106, the action of the spring 108 will outwardly return the button 106 thereby separating the contact elements 110, 112 and opening the circuit. The present invention is not limited to any particular switch and any suitable switch could be used, such as a slide switch.

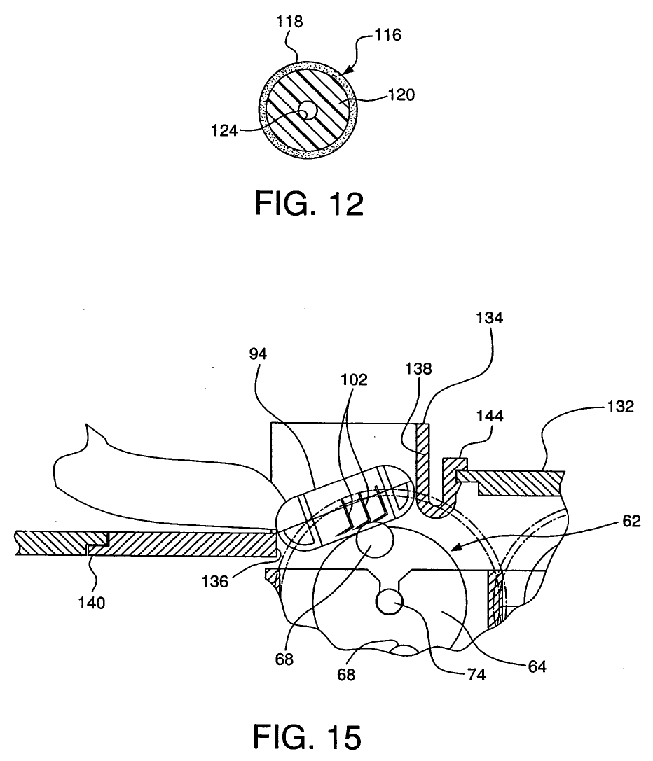

The above-described blade sharpener 40 of apparatus 10 includes a body 42 that is formed as a substantially solid piece of material having the desired abrasive properties, such as a sharpening stone material, for example. The use of a unitary material, however, is not required. Referring to FIG. 12, it is contemplated that a blade sharpener 116 could include a hollow outer member 118 made from a material having the desired abrasive properties, and an inner carrier member 120 received within an interior defined by the outer member 118. As shown, the inner carrier portion 120 includes a central passage 124 for mounting the inner carrier member 120 on a support shaft (not shown). The outer member 118 may be removable from the inner carrier portion 120, such as a removable abrasive sleeve, to permit replacement.

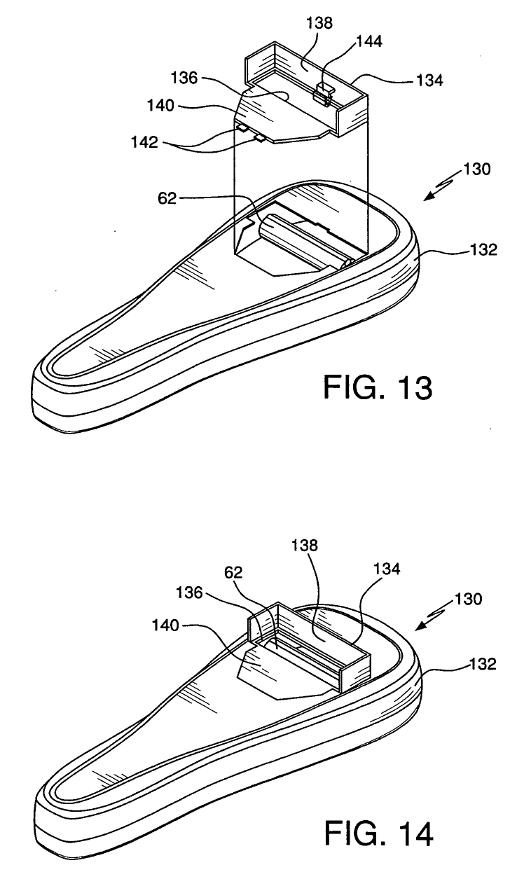

Referring to FIGS. 13 to 15, there is shown a sharpening apparatus 130 according to the invention including a housing 132 and a guide frame 134. As shown in FIGS. 13 and 14, the guide frame 134 is releasably attachable to the housing 132. The guide frame 134 includes an opening 136 and a rim 138 having upstanding walls located adjacent the opening 136. In the manner described above, the rim 138 of guide frame 134 serves to guide the blade head of a razor to the opening 136 such that the blades of the razor are properly positioned for sharpening by a blade sharpener 62, which is rotatably supported within an interior defined by the housing 132.

In the illustrated embodiment, the guide frame 134 includes a plate portion 140 connected to the rim 138. As shown, the plate portion 140 and rim 138 of guide frame 134 are dimensioned for interfitting receipt by a preferably correspondingly dimensioned opening 136 in the housing 132 such that the opening 136 in the guide frame 134 is located above the blade sharpener 62. Referring to FIG. 13, the guide frame 134 preferably includes tabs 142 connected to the plate portion 140 and a catch member 144 connected to the rim 138. The tabs 142 and catch member 144 serve to attach the guide frame 134 to the housing 132 in a similar fashion as removable housing portions of various electronic devices are releasably attached to provide access to a battery compartment. Thus, each guide frame may be configured to orient a specific blade head with a particular number of blades in its optimum position relative to the rods.

The releasable attachment of the guide frame 134 to the housing 132 provides for removal of the guide frame 134 for replacement by another guide frame. In this manner, the apparatus 130 could comprise a kit having a plurality of different guide frames each adapted for positioning a particular or series of razor types on the housing 132.

Referring again to FIG. 6, while the rod carrier 64 of blade sharpener 62 and the rods are shown as generally cylindrical in shape, it is contemplated that various other shapes can be used depending on the blades being sharpened. For example, the carrier may be oval in cross-section or have any other desired shape. Similarly, the rods can have an oval, polygonal or other shape. The shapes and sizes of the carrier and rods would be chosen to achieve greater or lesser contact with one or more of the blades depending on the type of blade being sharpened.

In each of the above-described apparatuses 10, 82, the output shaft of motor 52 is connected to the support shaft of the blade sharpener through meshingly engaging gears to transfer rotation of the motor shaft to the support shaft. It is within the scope of the invention, however, that the motor could engage the blade sharpener through other means, such as through an internal drive arrangement (i.e., the motor located within the carrier or body), that eliminates the need for gears, or other interconnecting members, to transfer rotation from a motor output shaft to the blade sharpener.

The previously described versions of the invention have many advantages, including achievement of electrically powered sharpening of razors. The razor sharpening apparatus described herein is also lightweight and includes relatively inexpensive components. It will be appreciated that the incorporation of an internal battery power of the razor sharpening apparatus permits the apparatus to be used in any location. Additionally, if used within a wet environment, the battery power does not present an electrical hazard to the user. However, it should be recognized that the present invention is not limited to the preferred use of batteries. On the contrary, a conventional electrical cord may be used to provide power to the device.

Although the present invention has been described in considerable detail with reference to certain preferred versions thereof, other versions are possible. For example, cylindrical support member could accommodate rods or other materials in configurations other than the longitudinal disposition described. Such alternatives could include rods that are disposed only half the length of one side of the cylindrical support member, alternating with rods that are offset and disposed along half the length of the other side of the cylindrical support member. Alternatively, as discussed above, in place of a manually operated switch, a sensor could automatically activate the motor of the present invention to provide for rotation for a fixed interval of time when a blade head is received within the razor sharpening apparatus.

Other patterns or configurations of abrasive materials disposed along the surface of the cylindrical support member could also be employed. In addition, power sources equally lightweight as a battery, including a wound spring mechanism, could be used to actuate the motor.

While the above discussion has described the use of abrasive rods as the contact elements, it is also contemplated that the apparatus may include a polishing element on the body. It is well known that polishing or stropping a blade enhances the sharpness of the blade. It is contemplated that a polishing element, for example, rubber or leather, could be incorporated into the body for contacting the blade(s) during sharpening. For example, one of the rods shown in FIGS. 5-7, may be replaced with a rod made from a polishing material. Alternatively, additional polishing rods can be incorporated between the sharpening rods shown. In another embodiment, the carrier shown in FIGS. 5-7 may include on its surface or be made from a material suitable for polishing, thus providing polishing of the blades between contact with the rods. It should be recognized that it may be desirable to form the rods from the polishing material and make the outer surface of the carrier from the abrasive material. With respect to the embodiment shown in FIGS. 3-4, it is contemplated that the outer surface 46 of the body may include specifically placed (e.g., alternating) portions or strips of abrasive and polishing material. The sleeve 118 shown in FIG. 12 may be similarly constructed.

The foregoing describes the invention in terms of embodiments foreseen by the inventor for which an enabling description was available, notwithstanding that insubstantial modifications of the invention, not presently foreseen, may nonetheless represent equivalents thereto.

1. An apparatus for sharpening the cutting edge of one or more blades of a blade head of a razor, the razor further including a handle connected to the blade head for manipulating the blade head, the apparatus comprising:
a housing defining an interior space and an opening adapted to receive the blade head of a razor;
a blade sharpener located within the housing adjacent to the opening, the blade sharpener rotatably supported for rotation about an axis, the blade sharpener including at least one sharpening element with an abrasive surface arranged for contact with at least one blade of a razor; and
a drive mechanism operably connected to the blade sharpener to rotate the blade sharpener about the axis.

2. The sharpening apparatus according to claim 1, wherein the blade sharpener includes an elongated body with a support shaft extending out from the body, the support shaft being supported in the housing so as to be rotatable about the axis, and wherein the body includes the sharpening element.

3. The sharpening apparatus according to claim 2, wherein the sharpening element is an outer surface formed on at least a portion of the body.

4. The sharpening apparatus according to claim 2, wherein the sharpening element is a rod mounted on the body.

5. The sharpening apparatus according to claim 4, wherein at least a portion of the body includes an outer surface of a polishing material.

6. The sharpening apparatus according to claim 2, wherein the body is formed from an abrasive material.

7. The sharpening apparatus according to claim 2, wherein the body includes a polishing material located on an outer portion of the body and arranged for contact with at least one blade of a razor.

8. The sharpening apparatus according to claim 1, wherein the blade sharpener includes a body with a support shaft extending out from the body, the support shaft being supported in the housing so as to be rotatable about the axis, wherein the body includes at least one rod mounted to it, the rod including a sharpening material, and wherein the body also includes a polishing material.

9. The sharpening apparatus according to claim 1, wherein the blade sharpener includes a body with a support shaft extending out from the body, the support shaft being supported in the housing so as to be rotatable about the axis, wherein the body includes at least one rod mounted to it, the rod including a polishing material, and wherein the body also includes a sharpening material.

10. The sharpening apparatus according to claim 2 wherein the drive mechanism includes a motor with an output shaft substantially parallel to the blade sharpener support shaft and offset therefrom, the apparatus further comprising first and second gears respectively connected to the motor output shaft and the blade sharpener support shaft, each of the first and second gears having teeth formed about an outer periphery, the teeth of the first and second gears meshingly engaging each other to transfer rotation of the motor output shaft to rotation of the blade sharpener support shaft during operation.

11. The sharpening apparatus according to claim 2, wherein the body is a carrier, the blade sharpener further including at least one rod received in a channel in the carrier, the rod having an outer portion located radially outward from the carrier for contact with a blade of a razor.

12. The sharpening apparatus according to claim 11, wherein the rod includes an abrasive material and wherein the sharpening element is the rod.

13. The sharpening apparatus according to claim 11, wherein there are a plurality of rods on the carrier and wherein at least one of the rods includes an abrasive material so as to form the sharpening element and wherein at least one of the rods includes a polishing material.

14. The sharpening apparatus according to claim 12, wherein the carrier is made from a plastic material and each of the rods comprises approximately 99 percent of an alumina ceramic material.

15. The sharpening apparatus according to claim 11, wherein the carrier is substantially cylindrical.

16. The sharpening apparatus according to claim 2, wherein the sharpening element is a hollow outer member disposed about the body, the outer member including an abrasive surface for contact with the blades of a razor.

17. The sharpening apparatus according to claim 1 further including a power source for the drive mechanism located within housing.

18. The sharpening apparatus according to claim 17, wherein the power source comprises at least one battery mounted within the housing.

19. The sharpening apparatus according to claim 18, wherein the battery is rechargeable.

20. The sharpening apparatus according to claim 1, wherein the housing includes side walls and a top, the opening being located in the top of the housing, and wherein the top of the housing provides for seated receipt of a razor when the blade head of the razor is received by the opening.

21. The sharpening apparatus according to claim 20, wherein the housing further includes a guide for positioning the blade head with respect to the blade sharpener, the guide including substantially upstanding walls located adjacent the opening.

22. The sharpening apparatus according to claim 20, wherein the top of the housing defines a recess adapted for nested receipt of a portion of the razor handle.

23. The sharpening apparatus according to claim 1 further comprising a switch mounted within the housing for selective actuation of the drive mechanism by a user of the apparatus.

24. The sharpening apparatus according to claim 23, wherein the switch includes a button slidably received by an opening in the housing and outwardly biased with respect to the housing by a spring, the switch further including first and second contact elements supported by the housing such that the contact elements are normally separated from each other, the first contact element being flexible such that inward movement of the button during actuation by a user results in deflection of the first contact element and contact between the first and second contact elements.

25. The sharpening apparatus according to claim 1 further comprising a sensor for detecting the presence of a blade head within the opening, the sensor sending a signal to activate the drive mechanism when a blade head is detected within the opening.

26. The sharpening apparatus according to claim 1 wherein the drive mechanism operates for a predetermined period of time when activated.

27. An apparatus for sharpening the cutting edge of one or more blades of a blade head of a razor, the razor including a handle connected to the blade head for manipulating the blade head, the apparatus comprising:
a housing defining an interior space and including side walls, a top and a bottom, the top of the housing including an opening adapted to receive the blade head of a razor, the housing including an end portion adapted to receive at least a portion of the handle such that the razor is seated on the top of the housing when the blade head is received by the opening;
a blade sharpener located within the housing adjacent the opening, the blade sharpener including a carrier body having a support shaft extending out from the carrier body, the blade sharpener support shaft being supported by the housing for rotation of the carrier body about an axis, the blade sharpener further including a plurality of abrasive rods each received in a longitudinally extending channel formed in the carrier body, the abrasive rods and the carrier body channels respectively dimensioned such that a portion of each of the abrasive rods extends radially outward from the carrier body for contact with at least one blade of a razor when the rod is disposed within the channel;
an electric drive motor mounted in the interior space of the housing, the drive motor including an output shaft substantially parallel to the blade sharpener support shaft and offset therefrom;
first and second gears respectively connected to the motor output shaft and the blade sharpener support shaft, each of the first and second gears including a plurality of teeth about an outer periphery, the teeth of the first and second gears meshingly engaging each other to transfer rotation of the motor output shaft to rotation of the blade sharpener support shaft; and
a switch for selective actuation of the drive motor by a user, the switch including a pushbutton slidably mounted to the housing and a spring for outwardly biasing the pushbutton with respect to the housing, the switch further including first and second electrically conductive contact elements supported by the housing such that the contact elements are normally separated from each other, the first contact element being flexible to provide for deflection of the first contact during actuation of the switch by a user and contact between the first and second switch elements.

28. The sharpening apparatus according to claim 27, wherein the top of the housing includes an indented portion adjacent the opening to accommodate a razor having an angled handle.

29. An apparatus for sharpening the cutting edge of one or more blades of a blade head of a razor, the apparatus comprising:
a housing defining an interior space;
a blade sharpener located within the interior space of the housing and including at least one abrasive member, the blade sharpener supported for rotation about an axis;
a drive system operably engaged to the blade sharpener to rotate the blade sharpener about the axis during operation; and
at least one guide frame releasably attachable to the housing and including an opening for receiving a blade head of a razor, the guide frame also including a guide rim having at least one wall located adjacent the opening for positioning the blade head relative to the opening of the guide frame.

30. The apparatus according to claim 29, wherein there are a plurality of different guide frames each configured for receipt of the blade head of one or more different types of razors.

31. The sharpening apparatus according to claim 29, wherein the blade sharpener includes a body with a support shaft extending out from the body, the support shaft being supported in the housing so as to permit rotation of the body about the axis, and wherein the body includes the abrasive element.

32. The sharpening apparatus according to claim 31, wherein the sharpening element is an outer surface on at least a portion of the body.

33. The sharpening apparatus according to claim 31, wherein the body includes a polishing material on an outer portion of the body and arranged for contact with at least one blade of a razor.

34. The sharpening apparatus according to claim 31 wherein the drive mechanism includes a motor with an output shaft engaged with the support shaft such that rotation of the drive shaft produces rotation of the support shaft.

35. The sharpening apparatus according to claim 31, wherein the body is a carrier, and wherein the abrasive element is mounted to the carrier and protrudes outward from the carrier for contact with a blade of a razor.

36. The sharpening apparatus according to claim 35, wherein the abrasive element is a rod mounted within a channel in the carrier.

37. The sharpening apparatus according to claim 36, wherein there are a plurality of rods, each located within a separate channel in the carrier.

38. The sharpening apparatus according to claim 37, wherein at least one of the rods includes a polishing material.

39. The sharpening apparatus according to claim 37, wherein the carrier is made from a plastic material and each of the rods comprises approximately 99 percent of an alumina ceramic material.

40. The sharpening apparatus according to claim 35, wherein the carrier is substantially cylindrical.

41. The sharpening apparatus according to claim 31, wherein the abrasive element is an outer sleeve disposed about the body, the outer sleeve including an abrasive surface for contact with the blades of a razor.

42. The sharpening apparatus according to claim 29 further including a power source located within the housing and electrically connected to the drive system.

43. The sharpening apparatus according to claim 42, wherein the power source comprises at least one battery.

44. The sharpening apparatus according to claim 43, wherein the battery is rechargeable.

45. The sharpening apparatus according to claim 29 further comprising a switch for selective actuation of the drive mechanism by a user of the apparatus.

46. The sharpening apparatus according to claim 45, wherein the switch includes a button slidably received by an opening in the housing and outwardly biased with respect to the housing by a spring, the switch further including first and second contact elements supported by the housing such that the contact elements are normally separated from each other, the first contact element being flexible such that inward movement of the button during actuation by a user results in deflection of the first contact element and contact between the first and second contact elements.

47. The sharpening apparatus according to claim 29 further comprising a sensor for detecting the presence of a blade head within the opening, the sensor sending a signal to activate the drive system when a blade head is detected within the opening.

48. The sharpening apparatus according to claim 29 wherein the drive mechanism operates for a predetermined period of time when activated.

49. The sharpening apparatus according to claim 29, wherein the blade sharpener includes a body with a support shaft extending out from the body, the support shaft being supported in the housing so as to be rotatable about the axis, the body having at least one rod mounted to it, the rod including a sharpening material, and wherein the body also includes a polishing material.

50. The sharpening apparatus according to claim 49, wherein the polishing material is on a surface of the body adjacent to the rod.

51. The sharpening apparatus according to claim 49, wherein the polishing material is on at least one other rod mounted to the body.

52. The sharpening apparatus according to claim 29, wherein the blade sharpener includes a body with a support shaft extending out from the body, the support shaft being supported in the housing so as to be rotatable about the axis, the body having at least one rod mounted to it, the rod including a polishing material, and wherein the body also includes a sharpening material.

53. The sharpening apparatus according to claim 52, wherein the sharpening material is abrasive material on a surface of the body adjacent to the rod.

54. The sharpening apparatus according to claim 52, wherein the sharpening material is abrasive material on at least one other rod mounted to the body.
